(19) United States
(12) Patent Application Publication
(10) Pub. No.: US 2022/0313562 A1
(43) Pub. Date: Oct. 6, 2022

(54) VIBRATING ORAL COMFORT DEVICE AND METHOD OF ASSEMBLY FOR DEVICE

(71) Applicant: Heather Vargo, West Chester, OH (US)

(72) Inventor: Heather Vargo, West Chester, OH (US)

(21) Appl. No.: 17/845,087

(22) Filed: Jun. 21, 2022

Related U.S. Application Data
(63) Continuation of application No. 16/675,163, filed on Nov. 5, 2019.
(60) Provisional application No. 62/756,051, filed on Nov. 5, 2018.

(51) Int. Cl. A61J 17/02

(52) U.S. Cl. CPC A61J 17/02

(57) ABSTRACT

A vibrating teething device includes a silicon outer shell that is larger than a human mouth and having protrusions that can fit within a human infant mouth; a battery powered vibrator encased within an open cavity in the silicon outer shell; and a cap fastened over the open cavity.

### CLAIM OF PRIORITY UNDER 35 U.S.C. § 120

The present application is a continuation of U.S. patent application Ser. No. 16/675,163 entitled “Vibrating Oral Comfort Device and Method of Assembly for Device” filed 5 Nov. 2019, which claimed the benefit of U.S. Provisional Application No. 62/756,051 entitled “Vibrating Oral Comfort Device and Method of Assembly for Device” filed 5 Nov. 2018, and assigned to the assignee hereof, both hereby expressly incorporated by reference herein.

### BACKGROUND

### 1. Technical Field

The present disclosure relates in general to child teething objects.

### 2. Description of the Related Art

Teething is the process of growing one's teeth and one of the main concerns for parents when going through development. Generally speaking, baby teeth begin to erupt around six months of age on average, but many begin the urge of teething months before.

Many teething devices are sold on the market today to provide infants and toddlers a safe way to obtain relief from teething. Teething devices are typically made out of rubber, silicone, wood, or other materials that provide resilient surfaces that are hygienic and suitable for soothing the pain of teething. Teethers are often provided in the form of a ring or other shapes and animals. However, sometimes the teether is too difficult for use by children without the ability to hold and use them in your hands, such as very young infants who lack the hand-eye coordination to manipulate hand-held objects.

With the many different types of teethers available, none of them can bring comfort to a child for more than a few minutes and/or not make a mess (i.e., silicone, freezable teethers, and teething nets). Once again, the parent is back to square one trying to figure out how to ease the pain.

Teethers in general have come a long way since the beginning. However, many of them rely solely on the tactile properties of the teether to give relief to the children. There is a need for improved teethers that can provide greater relief than offered by traditional teethers.

It is known to add a vibrating motor to a pacifier as is described in U.S. Pat. No. 6,193,742. The disadvantages are that the device in controlled solely by a rotary switch and requires that the electronic controls separated from the teething device. The use of the rotary switch and the small battery size results in the need for frequent battery replacement.

An improvement for a vibrating teether is disclosed in U.S. Pat. No. 7,211,102 where the rotary switch is replaced by a pressure switch and a timer. The combination of the pressure switch and timer results in significantly fewer battery replacements. A disadvantage is that the electronics, including the battery, have to be permanently sealed or the device cannot be sanitized with water or another liquid. If the device is permanently sealed, it becomes useless once the battery dies. Another disadvantage is that children begin teething at such a young age and they don't have the knowledge or strength to bite down on the teether in order to make it vibrate. The vibrating teethers of the prior art all suffer from various deficiencies.

### BRIEF SUMMARY

In accordance with the teachings of the present disclosure, a device is provided for massaging the gums and cleaning the teeth of an infant. The device consisting of a handheld, oral-safe, vibrating object corresponding to the five senses of the infant. The bitten object having massage and cleaning projections on outside surface for upper and lower part of jaw.

In one or more embodiments, the bite-on object having connected protruding parts, formed by means of a two or three component injection molding process so that the said bite-on parts are connected in a non-detachable manner and for an easy grip for infant to hold controllably.

In accordance with another embodiment of the present disclosure, the bite-on object has a deep orifice at bottom where one small screw attaches a non-detachable cap where vibrator and battery are placed inside for protection. The housing/bite-on portion is consisted of safe materials that will not harm the child.

According to illustrative embodiments of the present disclosure, an oral comfort device is provided in the form of an improved teether that includes a mechanism to provide vibration that will soothe the child's tender, swollen gums for a fixed period of time. In a preferred mode of operation, the teether is activated by the caretaker of the child with the squeeze of a button that is located internally.

The above presents a general summary of several aspects of the disclosure in order to provide a basic understanding of at least some aspects of the disclosure. The above summary contains simplifications, generalizations and omissions of detail and is not intended as a comprehensive description of the claimed subject matter but, rather, is intended to provide a brief overview of some of the functionality associated therewith. The summary is not intended to delineate the scope of the claims, and the summary merely presents some concepts of the disclosure in a general form as a prelude to the more detailed description that follows. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a side view of a teething device having an outer shell that disassembled from a cap, according to one or more embodiments;

FIG. 2 illustrates a side view of the teething device of FIG. 1 with the outer shell depicted in phantom and combined with rechargeable battery and charger, according to one or more embodiments; and

FIG. 3 illustrates a side view of the teething device of FIG. 1 with the outer shell depicted in phantom and combined with disposable battery, according to one or more embodiments.

### DETAILED DESCRIPTION

According to one aspect of the present disclosure, a device is provided for massaging the gums and cleaning the teeth of an infant. The device consisting of a handheld, oral-safe, vibrating object corresponding to the five senses of the infant. The bitten object having massage and cleaning projections on outside surface for upper and lower part of jaw. In one or more embodiments, the bite-on object having connected protruding parts, formed by means of a two or three component injection molding process so that the said bite-on parts are connected in a non-detachable manner and for an easy grip for infant to hold controllably. The bite-on object has a deep orifice at bottom where one small screw attaches a non-detachable cap where vibrator and battery are placed inside for protection. The housing/bite-on portion is consisted of safe materials that will not harm the child.

An oral comfort device in the form of an improved teether that includes a mechanism to provide vibration that will soothe the child's tender, swollen gums for a fixed period of time. In a preferred mode of operation, the teether is activated by the caretaker of the child with the squeeze of a button that is located internally. The vibration will have three modes (soft, strong, and pulsating) that will last for a maximum of 1.5 minutes (or a time near that). The vibration will end after 1.5 minutes lack of activity. The teether has an exterior of the type that is customary to apparatus, that is, having a soft, compressible surface, whether smooth or irregular.

Illustratively, the device includes a button, censored timer, battery, and an electric-powered vibrator motor. Preferably, these are all contained internally in the device.

When the caretaker pushes the button, the teether will begin to vibrate. The vibrating begins on mode 1 (soft). Pushing a second time will change it to mode 2 (strong). And pushing a third time will switch the teether to mode 3 (pulsating). The teether will continue to vibrate until it senses a lack of activity for a maximum of 1.5 minutes. In order to manually turn off the teether, the caretaker will hold the button for a total a three seconds and it will automatically turn off.

In one or more embodiments, the vibrating teether device comprises a mouth portion of a size suitable for partial or full insertion into the mouth of a child; a housing impervious to liquid having a body and a removable cap, the housing adapted to couple the teething portion and the removable cap and to contain a sensor associated with the teething portion, a removable power source, a vibrator operatively coupled to the mouth portion, and a controller having an input from the sensor and an output for driving the vibrator. In another embodiment the cap is non-removable. In another embodiment the controller further comprises a timer for controlling the duration of operation of the vibrator. In another embodiment the sensor is a motion activated sensor. In another embodiment the teether housing portion is constructed of silicone.

The housing further comprises a ring adapted to receive the removable cap and a printed circuit board for mounting the sensor, the power source, the vibrator and the controller. In another embodiment the housing is removably attached to the cap. In another embodiment the housing is connected to the cap to form a non-detachable connection. In another embodiment the mouth portion is a teether having a textured surface. In another embodiment a face plate is fixed to the housing, and a distance between the face plate and a top of the mouth portion is less than 35 mm.

In another embodiment the housing further comprises a cap ring and the removable cap and cap ring are constructed of nylon. In another embodiment the housing further comprises a user input adapted to receive and transmit user commands to the controller. In another embodiment the non-detachable cap connects to a charger that will recharge the devices battery when needed.

In another embodiment a method for assembling a child's vibrating oral comfort device comprises constructing a cap ring of nylon; attaching to the cap ring a printed circuit board having a sensor, a battery holder, a vibrator and a controller, molding a silicone shell and inserting the cap ring into the silicone shell to form a housing; attaching a cap to the cap ring; constructing a mouth portion of silicone; and fastening the mouth portion to the housing. In another embodiment the method includes a step of attaching a battery to the battery holder. In another embodiment the mouth portion is fastened to the housing with an adhesive to form a liquid tight bond. In another embodiment the housing is removably attached to a cap.

In another embodiment a child's vibrating oral comfort device comprises a housing having a cap, a cap and a face plate; a mouth portion of a size suitable for partial of full insertion into the mouth of a child, the mouth portion fixed to and extending away from the housing face plate positioned so that a child may put the mouth portion into the child's mouth; a printed circuit board fixed to the housing cap and having a sensor arranged to detect motion applied to the mouth portion, a power source holder, a vibrator operatively coupled to the mouth portion, and a controller responsively coupled to the sensor and controllingly coupled to the vibrator to control an aspect of its operation. In another embodiment the housing has an outer shell constructed of silicone and is fixed around the cap leaving an opening for receiving the removable cap. In another embodiment the mouth portion is constructed of silicone. In another embodiment the sensor senses the amount of motion. In another embodiment there is a user input adapted to receive and transmit user commands to the controller.

In one embodiment the device will have an area that can connect a teething ring that is freezable and can be immersed in liquid for sanitation purposes.

In one embodiment the vibration is provided for a period of time until it notices a lack of motion after three minutes.

In one embodiment the vibration is provided in three different settings. The first setting is at a lower vibration for a gentle massage. The second setting is at a higher vibration for a more intense massage. The last setting is set at a pulsating vibration for a different massage feeling.

It will be appreciated that the vibrator may be, but need not be, contained in the specific mouth portion of the device that enters the child's mouth. If not in that mouth portion, the vibrator is preferably mechanically coupled to the mouth portion that enters the mouth to an extent sufficient to cause vibration of the portion on which the child sucks or bites.

In one or more embodiments, the teething device has a body that includes one or more chewable protrusions made of an elastomeric material. In one or more embodiments, at least a portion of the one or more chewable protrusions has a textured surface.

Furthermore, the teething device may have protruding parts that allows the child to bring the device to his/her mouth without having to grasp it with their hands. This feature allows the teether to be used by a child who is unable to grasp the device—for example, very young infants before they develop the coordination to grasp objects. In one or more embodiments, the body of the teething device comprises one or more protrusions that provide a means for holding the device should a teething child wish to use the device without the assistance of a caregiver.

In one or more embodiments, the chewable protrusions can be in any shape or size that provides an adequate surface for the teething child to bite or chew and/or for the teething child to hold.

In one or more embodiments, the chewable surfaces of the teething device are made of an elastomeric material. The elastomeric material may be any natural or synthetic nontoxic material. For example, the elastomeric material may be a rubber material. The rubber material could be any FDA approved rubber material intended for repeated use, as designated in 21 C.F.R. Section 177.2600(c)(4), which is incorporated by reference. In some embodiments, the rubber material is silicone, and preferably is FDA food-grade silicone. The elastomeric material comprising the body and the chewable portions can be the same or can be different, including any combination of the materials referenced above.

In some embodiments the chewable portions of the device may be made of silicone or other oral-safe materials.

In accordance with certain embodiments, elastomeric material may contain one or more materials to inhibit bacterial, microbial and/or fungal growth. The use of materials to inhibit bacterial, microbial and/or fungal growth within fibers and fabrics is well known, and includes the use of both organic and inorganic agents. Non-limiting and illustrative examples of some types of agents that may be used in accordance with the present teachings include, but are not limited to, antimicrobial polymerizable compositions containing an ethylenically unsaturated monomer, di-functional or tri-functional antimicrobial monomers and polymerization initiators, silver containing antimicrobial agents comprising carboxymethylcellulose, crosslinked compounds containing silver and/or silver salts of carboxymethylcellulose, organic solvent-soluble mucopolysaccharides consisting of ionic complexes of at least one mucopolysaccharide and a quaternary phosphonium, antibacterial antithrombogenic compositions comprising organic solvent-soluble mucopolysaccharides and organic polymeric materials, antibacterial antithrombogenic compositions comprising organic solvent-soluble mucopolysaccharides and inorganic antibacterial agents, and silver, copper, and/or zinc components incorporated into the elastomeric material.

In one or more embodiments, the teething device can also have a means for providing a cooling sensation to the teething child. In one embodiment, this is through the use of a one or more cavities located within the body of the device. The one or more cavity can be filled with a liquid or gel that can retain cooling properties after the device is removed from a refrigerator or freezer.

The liquid or gel can act as a coolant to the teething child's gums. The liquid or gel can either act naturally as a coolant, or can be cooled by placing the multi-purpose teething device in the refrigerator or freezer. The liquid or gel acts as a coolant by retaining their cooling properties after removing the device from the refrigerator or freezer. In some embodiments, the liquid or gel can be, for example, water, hydroxypropyl methylcellulose, ammonium nitrate, hydroxyethyl cellulose, silica gel, propylene glycol, or any other food grade, freezable liquid or gel, or a combination thereof. If the liquid or gel is water, the water can be distilled or sterile water. Moreover, the liquid or gel may be any other material that is non-toxic and has favorable cooling properties. In some embodiments, the liquid or gel is sealed within one or more cavities. In other embodiments, the liquid or gel can be removed from the one or more cavities and replaced.

In one or more embodiments, the teething device can also be used for one or more methods of treatments other than teething. In one embodiment, the teething device can be used to treat symptoms of congestion in an infant. In another embodiment, the teething device can be used to treat symptoms of ear pain in an infant. In another embodiment, the teething device can be used to treat symptoms of mastitis in an infant. In another embodiment, the teething device can be used to treat symptoms of two or more ailments in an infant.

The details of one or more embodiments practicing the invention are set forth in the accompanying drawings and the description herein. Other features, objects, and advantages of the invention will be apparent from the description and drawings, and from the claims. References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

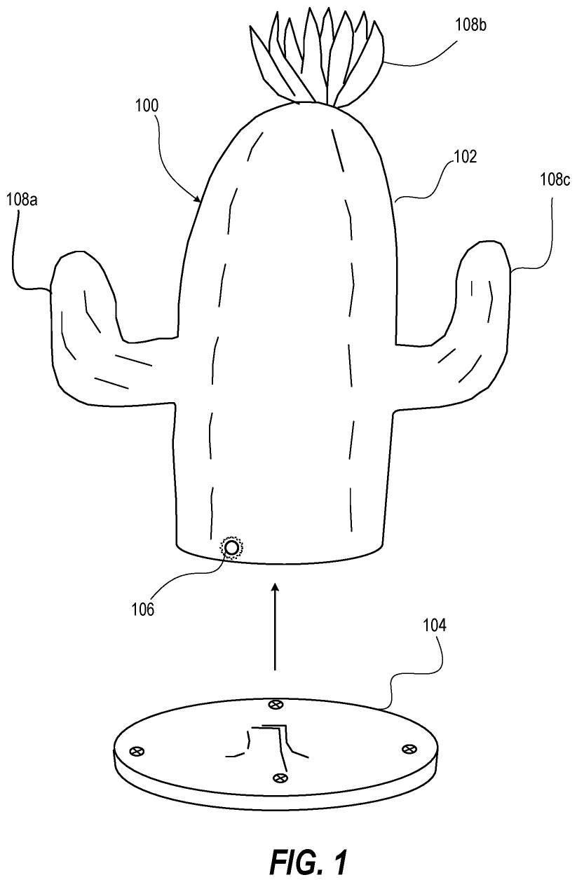

FIG. 1 depicts a side view of a vibrating teething device 100 having an outer shell 102 that is disassembled from a cap 104. The outer shell 102 is made out of silicone or something similarly non-toxic and safe for oral use. A battery status light 106 is attached to an exterior of the outer shell 102 and flashes red when battery charge is low. Protruding areas 108a-c from the outer shell 102 of the vibrating teething device that will add other senses of touch and other textures for reaching the pain in the child. Protruding parts 108a-c allow an easier grip for the child who will have little to no coordination at the time. The cap 104 is the base of the vibrating teething device 100 and is secured to the outer shell 102 of the vibrating teething device 100.

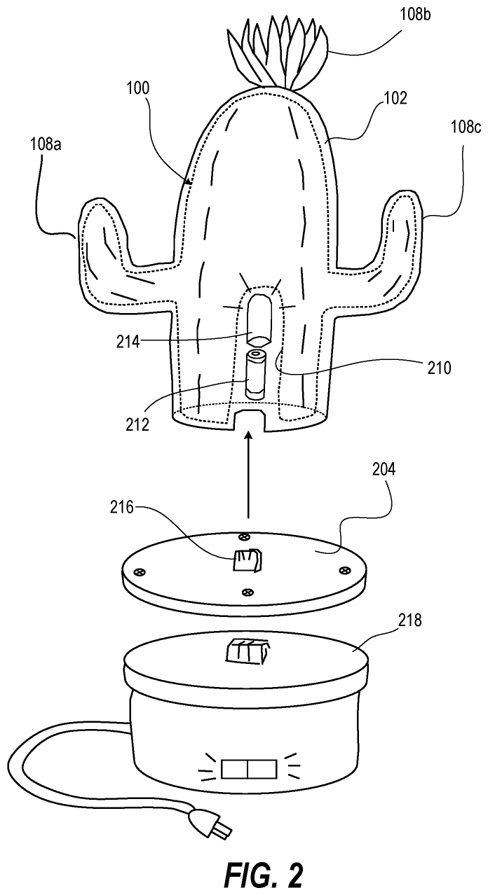

FIG. 2 depicts a side view of the teething device of FIG. 1 with the outer shell 102 having a hollow cavity 210 that contains a rechargeable battery 212 and a vibrator device 214. A cap 204 includes an electrical connector 216 that transfers electrical charge to the rechargeable battery 212 from a plug-in recharging base 218.

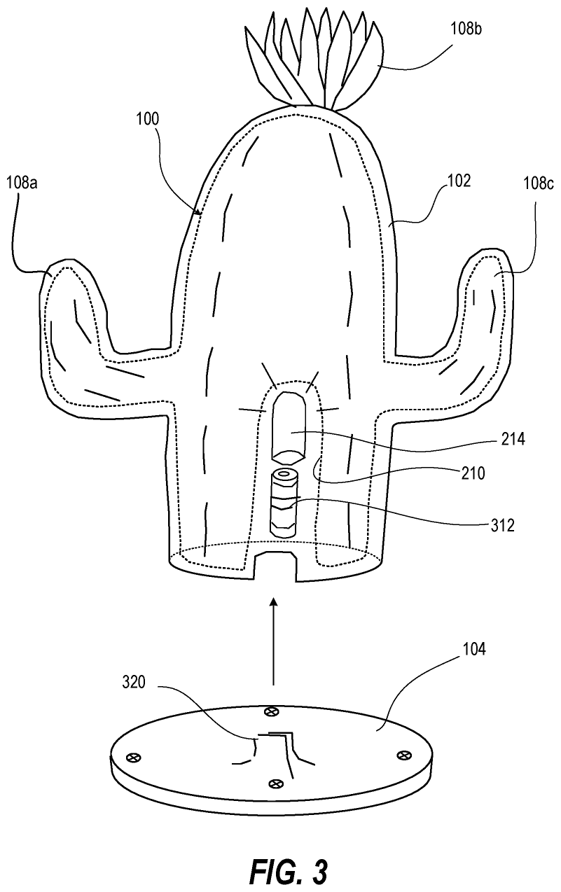

FIG. 3 depicts a side view of the teething device 100 of FIG. 1 with the outer shell 102 having the hollow cavity 210 that contains a disposable battery 312 and the vibrator device 214. The cap 104 includes an upward feature 320 that urges disposable battery 312 into electrical contact with the vibrator device 214.

In one or more embodiments, the vibrating teething device 100 includes a silicon outer shell having a body that is larger than a human mouth and having one or more protrusions that extend from the body presenting a free end that is configured to fit within and shaped to substantially correspond to a human infant mouth. Each protrusion individually has a shape and size that provides an adequate surface for a teething child to bite or chew and provides an adequate shape and size for the teething child to hold when not in the human infant mouth. The vibrating teething device 100 includes a battery-powered vibrator encased within an open cavity in the silicon outer shell. A cap is fastened over the open cavity.

In one or more embodiments, the vibrating teething device 100 includes a button and a censored timer. The battery-powered vibrator is an electric powered vibrator motor and a battery. The button, when depressed by a caregiver, changes a mode of the censored timer, which is powered by the battery, between an off mode and at last one active mode that causes the electric powered vibrator motor to vibrate until the censored timer deactivates the electric powered vibrator motor. In one or more particular embodiments, sequential activations of the button change the mode of the vibrating teething device from the off mode, through the at least one active mode, and to the off mode. In one or more embodiments, a motion transducer sensor provides a first electrical response when stationary and a second electrical response that is different from the first electrical response when moving. The censored timer deactivates the electric powered vibrator motor in response to determining, based on the motion transducer sensor providing the first electrical response, that the vibrating teething device has been stationary for more than a threshold period of time. In one or more specific embodiments, the at least one active mode includes a soft vibrating mode, a strong vibrating mode, and a pulsating vibrating mode. In one or more embodiments, the vibrating teething devices includes a battery charger that is capable of recharging the battery. In one or more embodiments, the one or more protrusions includes one or more cavities fillable with a cooling liquid or gel.

In another aspect of the present disclosure, a method is provided providing vibration and cooling to a human infant mouth that may provide a therapeutic effect to conditions such as teething, congestion, ear pain, and mastitis. The method includes filling one or more cavities in one or more protrusions of a vibrating teething device with a liquid or gel. The vibrating teething device includes a silicon outer shell having a body that is larger than a human mouth. The one or more protrusions extend from the body presenting a free end that is configured to fit within and shaped to substantially correspond to a human infant mouth. Each protrusion individually has a shape and size that provides an adequate surface for a teething child to bite or chew and provides an adequate shape and size for the teething child to hold when not in the human infant mouth. The method includes cooling the vibrating teething device. The method includes activating a battery-powered vibrator encased within an open cavity in the silicon outer shell to provide a vibration mode of the vibrating teething device.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A vibrating teething device comprising:
a silicon outer shell having a body that is larger than a human mouth and having one or more protrusions that extend from the body presenting a free end that is configured to fit within and shaped to substantially correspond to a human infant mouth, each protrusion individually having a shape and size that provides an adequate surface for a teething child to bite or chew and provides an adequate shape and size for the teething child to hold when not in the the human infant mouth;
a battery-powered vibrator encased within an open cavity in the silicon outer shell; and
a cap fastened over the open cavity.

2. The vibrating teething device of claim 1, further comprising a button and a censored timer, wherein:
the battery-powered vibrator comprises an electric powered vibrator motor and a battery;
the button, when depressed by a caregiver, changes a mode of the censored timer, which is powered by the battery, between an off mode and at last one active mode that causes the electric powered vibrator motor to vibrate until the censored timer deactivates the electric powered vibrator motor.

3. The vibrating teething device of claim 2, wherein sequential activations of the button change the mode of the vibrating teething device from the off mode, through the at least one active mode, and to the off mode.

4. The vibrating teething device of claim 2, further comprising a motion transducer sensor that provides a first electrical response when stationary and a second electrical response that is different from the first electrical response when moving, the censored timer deactivates the electric powered vibrator motor in response to determining, based on the motion transducer sensor providing the first electrical response, that the vibrating teething device has been stationary for more than a threshold period of time.

5. The vibrating teething device of claim 4, wherein the at least one active mode comprises a soft vibrating mode, a strong vibrating mode, and a pulsating vibrating mode.

6. The vibrating teething device of claim 2, further comprising a battery charger that is capable of recharging the battery.

7. The vibrating teething device of claim 1, wherein the one or more protrusions further comprises one or more cavities fillable with a cooling liquid or gel.

8. The vibrating teething device of claim 1, wherein the one or more protrusions comprises one or more cavities filled with a cooling liquid or gel.

9. A method, comprising:
filling one or more cavities in one or more protrusions of a vibrating teething device with a cooling liquid or gel, the vibrating teething device comprising a silicon outer shell having a body that is larger than a human mouth, the one or more protrusions extending from the body presenting a free end that is configured to fit within and shaped to substantially correspond to a human infant mouth, each protrusion individually having a shape and size that provides an adequate surface for a teething child to bite or chew and provides an adequate shape and size for the teething child to hold when not in the human infant mouth;
cooling the vibrating teething device; and
activating a battery-powered vibrator encased within an open cavity in the silicon outer shell to provide a vibration mode of the vibrating teething device to provide a vibrating and cooling effect that is configured to treat conditions selected from one of teething, congestion, ear pain, and mastitis when the one or more protrusions are positioned in the human infant mouth.
